(19) United States
(12) Patent Application Publication
(10) Pub. No.: US 2011/0106498 A1
(43) Pub. Date: May 5, 2011

(54) STATUS DETECTING DEVICE FOR IEPE PIEZOELECTRIC ACCELERATION SENSOR

(75) Inventor: Ronald Paul Denton, SR., Heathsville, VA (US)

(73) Assignee: Wilcoxon Research, Inc.

(21) Appl. No.: 12/895,843

(22) Filed: Sep. 30, 2010

(30) Foreign Application Priority Data
Jan. 23, 2008 (CN) 200820101273.5

(51) Int. Cl. G06F 15/00; G01P 21/00

(52) U.S. Cl. 702/182

(57) ABSTRACT

A detecting device for determining the status of an IEPE piezoelectric acceleration sensor is disclosed. The detecting device comprises a battery power supply management system, an IEPE sensor operating power supply management system, an IEPE operating status detection system, a microprocessor control system, a low battery LED indicator, a sensor operating status LED indicator, a universal meter/voltage meter interface, and a characteristic signal generating system. Therefore, a display system may be removed from the detecting system, thereby providing improved convenience for technicians tasked with sensor maintenance and also making the detecting device more portable.

### CROSS-REFERENCE TO RELATED APPLICATIONS

This patent application is based on Chinese Patent Application No. 200820101273.5, filed on Jan. 23, 2008, published on Sep. 30, 2009, the entire contents of which is hereby expressly incorporated by reference.

### FIELD OF THE INVENTION

The present invention relates to a detecting device, more specifically, to a detecting device for determining the working status and the performance of circuits of an IEPE (Integrated Electronics Piezo Electric) acceleration sensor, which is usually referred to as an ICP (Integrated Circuit Piezoelectric) type piezoelectric acceleration sensor.

### BACKGROUND

An IEPE piezoelectric acceleration sensor, which is regularly referred to as an ICP type piezoelectric acceleration sensor, is currently largely used in the industrial, environmental, military, and aviation fields. It is also used for device monitoring, environmental monitoring, and measuring experiment, etc. Use and maintenance of a sensor usually requires one to conduct a performance analysis and fault diagnosis of the working status and the interconnecting circuits of the sensor.

Normally, the detecting device of an IEPE type piezoelectric acceleration sensor comprises: a battery power supply management system, an IEPE (ICP) sensor power supply management system, an IEPE (ICP) sensor operating status detecting system, a microprocessor control system, a sensor operating status LED indicator, a low battery LED indicator, a characteristic signal generating system, and a voltage display system. Because of the screen, the display system usually comes in a large volume and it is, therefore, not convenient to carry. In addition, in the tool box of a technical person, an universal meter or an electric voltage meter is usually a necessity.

Therefore, a need continues to exist for a fast, accurate, intelligent, and stable detecting device for determining the working status and the performance of interconnecting circuits of an IEPE piezoelectric acceleration sensor. A need also continues to exist for an easy to carry and use detecting device for determining the working status and the performance of interconnecting circuits of an IEPE piezoelectric acceleration sensor.

### SUMMARY OF THE INVENTION

The present invention is directed to a detecting device for determining the working status and the performance of interconnecting circuits of an IEPE piezoelectric acceleration sensor for providing a fast, accurate, intelligent, and stable examination of the working status and the performance of interconnecting circuits of the piezoelectric acceleration sensor, and for an easy to carry and use detecting device for the piezoelectric acceleration sensor.

The detecting device for determining the working status and the performance of interconnecting circuits of an IEPE piezoelectric acceleration sensor may comprise: a 9V battery power supply management system, an IEPE (ICP) sensor operating power supply management system, an IEPE (ICP) operating status detection system, a microprocessor control system, a low battery LED indicator, a sensor operating status LED indicator, a universal meter/voltage meter interface, and a characteristic signal generating system.

The IEPE (ICP) sensor operating power supply management system may be powered by the 9V battery power supply. A DC-DC chip and related peripheral electronic components can form a 24V power supply voltage circuit, which can provide a steady 2.4 mA current source to the IEPE (ICP) sensor.

Through an embedded program according to different user key operations, the microprocessor control system may control each system to carry out corresponding operations and control the low battery LED indicator and working status indicator.

The characteristic signal generating system may provide a general standard for emulating the sensor output signal for circuit analysis.

The universal meter/voltage meter interface may comprise one or more universal meter/voltage meter connectors.

When the sensor is powered by the power supply, a technical worker can easily plug the instrument into the universal meter/voltage meter. In other words, the positive and negative connectors on the back side of the instrument can be, respectively, plugged into the positive and negative connectors of the universal meter/voltage meter. The B0V (bias voltage) signal can be read directly from the universal meter/voltage meter. Therefore, there is no need to carry extra display devices. Therefore, a fast, accurate, intelligent, and stable detection of the working status and the performance of interconnecting circuits of the piezoelectric acceleration sensor can be performed. In addition, the detecting device is easy to carry by a technical person.

### BRIEF DESCRIPTION OF THE DRAWINGS

FIG. 1 is a schematic illustration of the function of an integral system according to one embodiment of the present invention.

FIG. 2 is a schematic illustration of a circuit schematic diagram of the power supply management system of an IEPE (ICP) sensor according to one embodiment of the present invention.

FIG. 3 is a schematic illustration of the structure of an IEPE (ICP) sensor according to one embodiment of the present invention.

### DETAILED DESCRIPTION OF THE PREFERRED EMBODIMENTS

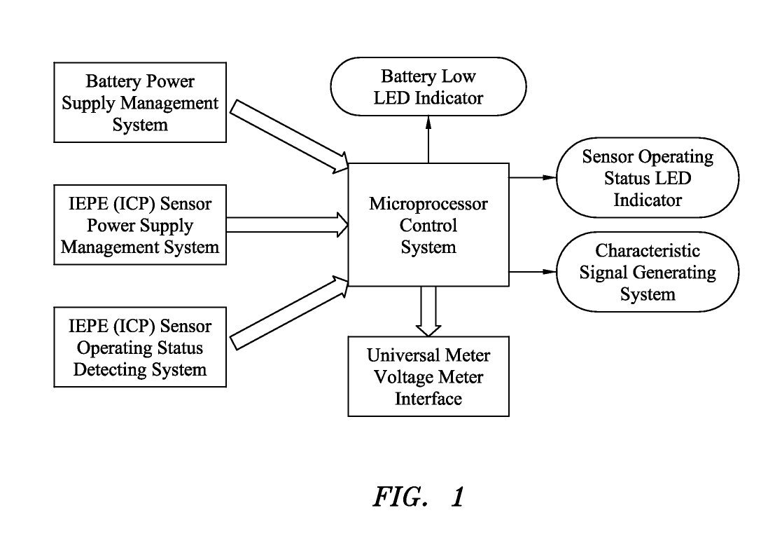

The present invention is directed to a detecting device for determining the status of an IEPE piezoelectric acceleration sensor. As shown in FIG. 1, the detecting device may comprises: a power supply management system, such as a 9V battery power supply management system, an IEPE (ICP) sensor operating power supply management system, an IEPE (ICP) operating status detection system, a microprocessor control system, a low battery LED indicator, a sensor operating status LED indicator, a universal meter/voltage meter interface, and a characteristic signal generating system.

The 9V battery power supply management system may comprise a common 9V battery.

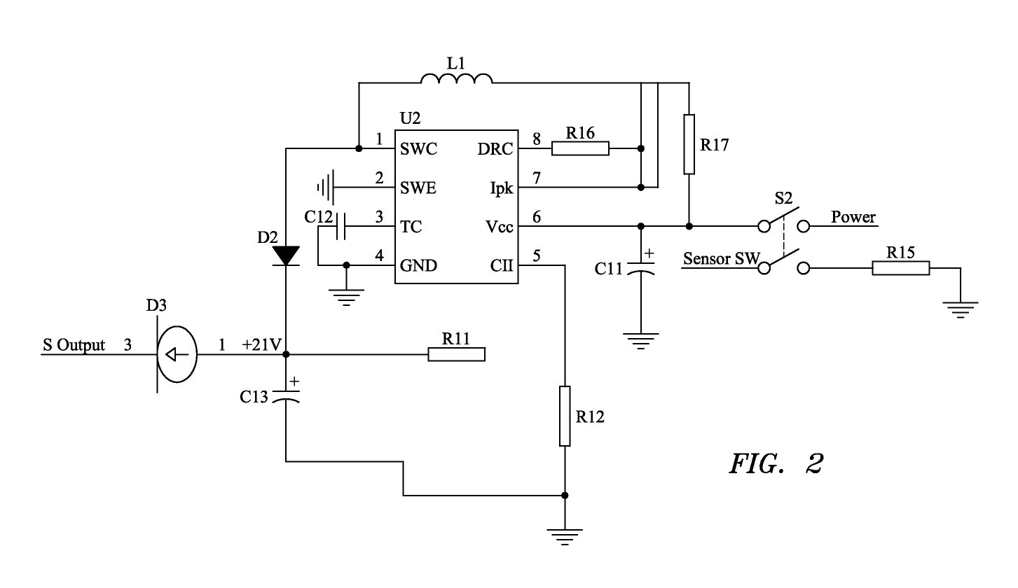

Referring to FIG. 2, the IEPE (ICP) sensor operating power supply management system may comprise a 24V sensor power supply circuit, which further includes a DC-DC chip U2, resistor R11, resistor R12, resistor R15, resistor R16, resistor R17, inductor L1, diode D2, capacitor C11, capacitor C12, and capacitor C13. Pin 6 (Vcc) of chip U2 may be connected to the 9V battery power supply. Pin 6 may also be connected through capacitor C11, which is connected to ground, to filter high frequency power supply wave. Further, Pin 6 (Vcc) may also be connected to pin 7 (Ipk) through resistor R17. Pin 7 (Ipk) may be connected to pin 8 (DRC) through resistor R16. Pin 7 (Ipk) may also be connected to pin 1 (SWC) through inductor L1. Pin 1 (SWC) may be connected to the input of diode D3 through diode D2. Pin 2 (SWE) may be connected to ground. Pin 3 (TC) may be connected to pin 4 (GND) through capacitor C12. Pin 4 (GND) may also be connected to ground. Pin 5 (CH) may be connected to the input of diode D3 through resistor R12. Input of diode D3 may also be connected to ground through capacitor C13. The output of D3 can be the output of the 24V steady power supply circuit for the IEPE (ICP) sensor. The sensor power supply system can provide most of the universal IEPE (ICP) sensor with a stable power supply. The status of power supply can be controlled and managed through the key switches and/or the built-in microprocessor control system.

The IEPE (ICP) work status detection system can be examined through a real time monitoring of the sensor B0V value, by, for example, monitoring the bias voltage for B0V value, to realize the examination of the connected IEPE (ICP) sensor work status and performance of interconnected circuits.

The low battery LED indicator can be turned on when the battery is lower than a pre-selected voltage value (e.g., 7V for a 9V battery) for reminding the user to change the battery.

The sensor operating status LED indicator is used to remind the user of a variety of fault models through different color LEDs, which can be controlled by the microprocessor control system based on the detected sensor bias voltage of the IEPE (ICP) piezoelectric acceleration sensor. A user is able to realize the fault model through the sensor operating status LED indicator and the voltage value of sensor B0V. For example, when the yellow LED is turned on and the value of sensor B0V is 0, it indicates that there is no power supply to the sensor or there is a short circuit; when the yellow LED is turned on and the value of B0V is between 2.5V and 7V, it indicates that there is damage on the amplifier of the sensor; when the yellow LED is turned on and the value of sensor B0V is between 5V and 7V, a technical manual of the sensor may be required to decide the possible cause, if it is within the normal voltage range indicated in the technical manual, it may be the damage of the sensor; when the green LED is turned on and the value of sensor B0V is between 7V and 15V, it indicates that the sensor is functioning normally; when the red LED is turned on and the value of sensor B0V is between 15V and 30V, it indicates that the power supply of the sensor is reversed or the sensor has short circuit.

The microprocessor control system can control each system to perform corresponding operations and control the low battery LED indicator and sensor operating status indicator through the embedded program according to different user key operations.

When the sensor is powered by the power supply, under an examination condition, a technical worker can easily insert the positive and negative connectors on the back side of the instrument into the positive and negative connectors of the universal meter/voltage meter, respectively, to display the voltage value of sensor B0V.

The characteristic signal generation system is based on the functional features of the IEPE (ICP) piezoelectric acceleration sensor to provide a general standard of emulating sensor output signal for circuit analysis on the interconnection of the sensor and consumption information.

The output signal may be generated by a sine wave generator with, for example, a peak-to-peak value of 100 mV and a frequency of 100 Hz to simulate a 1G gravity acceleration for a sensor. A technical worker can analyze the circuit performance based on the results from the display of an acceleration data collector.

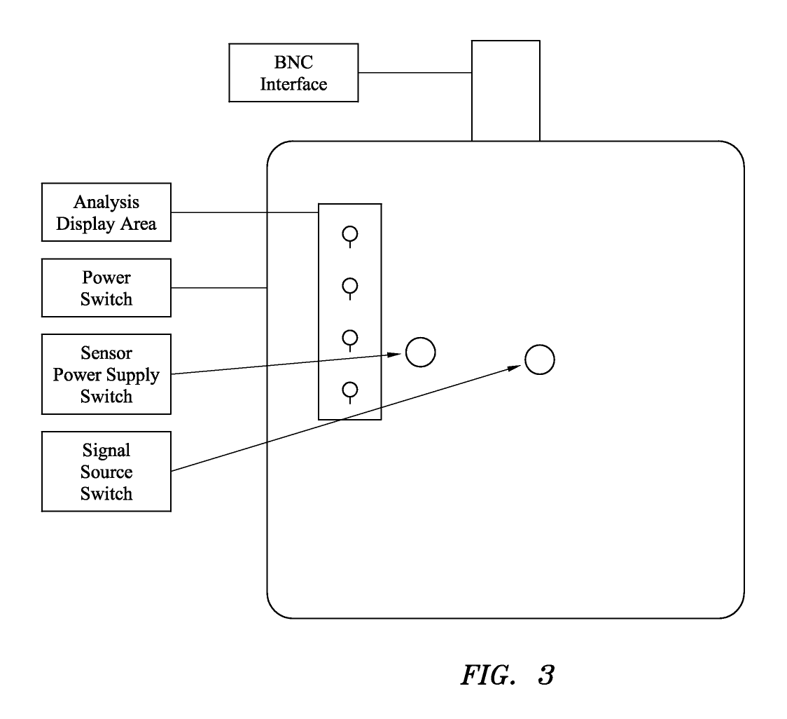

FIG. 3 shows that the structure of a sensor according to one embodiment of the present invention is compact, therefore, it is easy to maintain and carry.

Although the invention has been described with reference to preferred embodiments and specific examples, those of ordinary skill in the art will readily appreciate that many modifications and adaptations of the invention are possible without departure from the spirit and scope of the invention as claimed hereinafter.

1. A device for detecting the operating status of an IEPE type piezoelectric acceleration sensor, the device comprising:
a sensor power supply management system;
an operating status detection system;
a microprocessor control system having a battery power supply management system;
a low battery LED indicator;
a sensor operating status LED indicator; and
a characteristic signal generating system, wherein the microprocessor control system further has a universal meter/voltmeter interface for connecting to a universal meter/voltmeter.

2. A screen-less device for detecting the operating status of an IEPE type piezoelectric acceleration sensor, the device comprising:
a microprocessor control system; and
a universal meter/voltmeter interface electrically coupled to the microprocessor control system, wherein the universal meter/voltmeter interface is configured to connect to inputs of a universal meter/voltmeter.

3. The device according to claim 2, wherein when the universal meter/voltmeter interface is connected to the inputs of the universal meter/voltmeter, a value corresponding to the operating status of the IEPE sensor may be displayed from the universal meter/voltmeter.

4. The device according to claim 2, further comprising a power supply management system.

5. The device according to claim 4, wherein the power supply management system is a battery power supply management system.

6. The device according to claim 2, further comprising a sensor operating power supply management system, wherein the sensor operating power supply management system comprises a sensor power supply circuit to provide a steady current source to the IEPE type piezoelectric acceleration sensor.

7. The device according to claim 2, further comprising an operating status detection system electrically coupled to the microprocessor control system, wherein the operating status detection system is configured to monitor the IEPE sensor's bias output voltage (B0V) for examining of the operation and performance of the IEPE sensor.

8. The device according to claim 7, further comprising an operator input device electrically coupled to the microprocessor control system for controlling the operation of the microprocessor control system.

9. The device according to claim 2, further comprising a low battery LED indicator electrically coupled to the microprocessor control system, wherein the low battery LED indicator operatively controlled by the microprocessor control system.

10. The device according to claim 2, further comprising a sensor operating status LED indicator electrically coupled to the microprocessor control system, wherein the sensor operating status LED indicator operatively controlled by the microprocessor control system.

11. The device according to claim 10, wherein the sensor operating status LED indicator is configured to respond based on a bias output voltage (B0V) value of an IEPE type piezoelectric acceleration sensor being tested.

12. The device according to claim 2, further comprising a characteristic signal generating system, wherein the characteristic signal generating system is configured to provide a general standard for emulating the sensor output signal for circuit analysis.

13. A method for detecting the operating status of an IEPE type piezoelectric acceleration sensor by a status detecting device with a universal meter/voltmeter interface, the method comprising:
connecting a universal meter/voltmeter to the universal meter/voltmeter interface of the status detecting device; and
displaying a bias output voltage value of the IEPE type piezoelectric acceleration sensor on the universal meter/voltmeter.

14. The method according to claim 13, further comprising:
indicating the operating status of the IEPE sensor through a sensor operating status LED indicator on the status detecting device.

15. A device for detecting the operating status of an IEPE type piezoelectric acceleration sensor, the device comprising:
a power supply management system;
a status detection system;
a status indicator;
a characteristic signal generating system, and
a universal meter/voltmeter interface.

16. A device for checking the performance of a vibration sensor, the device comprising: a universal meter/voltmeter interface, wherein the universal meter/voltmeter interface is configured to connect to a universal meter/voltmeter.
